(19) United States
(12) Patent Application Publication
(10) Pub. No.: US 2011/0024939 A1
(43) Pub. Date: Feb. 3, 2011

(54) THERMOPLASTIC POLYACRYLONITRILE PRODUCTION PROCESS

(76) Inventor: Nilton Pereira Alves, Sao Jose dos Campos (BR)

Correspondence Address: JOHN ALEXANDER GALBREATH, 2516 CHESTNUT WOODS CT, REISTERSTOWN, MD, 21136, US

(21) Appl. No.: 12/510,575

(22) Filed: Jul. 28, 2009

(51) Int. Cl. B29C 47/00; C08K 5/053; C08K 5/09; C08K 5/095; C08K 5/10

(52) U.S. Cl. 264/141; 524/386; 524/319; 524/380; 524/315; 523/122

(57) ABSTRACT

“THERMOPLASTIC POLYACRYLONITRILE PRODUCTION PROCESS” describes the process that allows the thermoplastic polyacrylonitrile production by extrusion, a new material characterized by having in its composition the polymer polyacrylonitrile (PAN) plasticized with polyols, stabilizers and additives, which allows the acrylic fiber and carbon fiber production, it also allows other conformations in any equipment used in plastics industries as injectors, extruders and blowers. The thermoplastic polyacrylonitrile production process have the following steps: (I) prepare an acrylic or modacrylic polymer, polyols, stabilizers and additives mixture, (II) transfer the mixture to an extruder, (III) undergo to an extrusion process step, (IV) obtain the desired polymer shape directly into the extruder or pellets, (V) use the pellets in other equipments such as injection machines, blowers and extruders.

The polyacrylonitrile fusibility problem was resolved by fusing it into an extruder, together high polarity plasticizers substances, such as polyols and stabilizers such liquid inorganic acids and/or halogenated compounds such halohydrins, which delay or prevent the cyclization, in these conditions, the melted polymer can be formed into filaments or otherwise desired, the process also allows the production of blends with polymers such as PVC, PVDC and PVDF that have anti-flame properties and with the polymers PHB, PHV, and polylactic acid that are biodegradable.

This INVENTION PRIVILEGE patent request has the objective of describing the Thermoplastic Polyacrylonitrile production process, a new material characterized by having in its composition the polyacrylonitrile polymer plasticized with polyols, that allows the modacrylic and acrylic fibers and carbon fiber obtainment and also other conformations in any equipment commonly used in plastic industries like injectors, extruders, blowers, laminators, vacuum forming and presses.

Technical State

Is known that the polyacrylonitrile (PAN) homo and copolymerized with many monomers, commonly vinyl acetate, styrene, methyl metacrylate and methyl acrylate, when heated, the nitirilic group nitrogen suffers cyclization and consequently causes the cross links formation on the polymer chain, because of this there is no polymer fusion, resulting in a degraded product with total loss of the original polymer physical and mechanical properties.

This polyacrylonitrile feature, mainly used in textile fibers production, makes the spinning process done by traditional processes, where few improvements were made over the last decades and among these traditional processes these ones can be cited: the wet spinning process, where a polyacrylonitrile dissolution is done in a high polar solvent, being the most used ones the dimethylformamide (DMF), the dimethylacetamide (DMAc), the dimethyl sulfoxide (DMSO), the sodium thiocyanate solution, the zinc chloride solution and also the nitric acid in a concentration that provides the suitable viscosity to its pumping through the spinnerets immersed in a typically aqueous coagulation bath, where subsequently the filaments are drawn and dried. There is another process without the polyacrylonitrile solution coagulation, where the solvent is evaporated after the filaments leaving the spinneret (dry spinning).

As examples of acrylic fibers manufacturing processes by melting process currently available the ones can be cited:

a) Processes based in the utilization of melt processable acrylic polymers, U.S. Pat. Nos. 5,602,222/5,618,901/4,255,532, that describe the melting acrylic polymers obtaining process through the acrylonitrile copolymerization with many comonomers like metacrylonitrile, styrene, vinyl acetate, methyl metacrylate and methyl acrylate, polymerized together emulsifiers, alkyl-mercaptans, sodium bisulfite and ammonium persulfate as initiator; the polymers obtained in these described polymerization conditions present thermal, physical and mechanical properties suitable for extrusion and can be commercially found as Barex and Amlon brands. These polymers have a high cost which makes unviable many of its potential applications, mainly for textile fibers production.

b) Processes based on the polyacrylonitrile (PAN) fusion, U.S. Pat. Nos. 5,681,512/5,589,264/5,434,002, describe acrylic fibers obtantion processes by an extrusion of a gel constituted of a polyacrylonitrile and water mixture melted at high pressure; the 1968 U.S. Pat. No. 3,388,202 describes the polyacrylonitrile fusibility when mixed with water in a closed reactor with high pressure, condition where the polyacrylonitrile temperature stays below of its degradation temperature, what allows its extrusion and conformation; the 1976 U.S. Pat. No. 3,984,601 describes the water concentration and acrylic copolymers suitable for filaments and films manufacturing and, also, the extrusion conditions and the obtained filaments properties, the British patent number 1,327,140 describes the acrylic fibers obtantion by pre-molding the polymer in a high temperature and pressure, getting a dark brown fiber; the 1990 European patent number 89115373,6 describes detailed equipment and process used to produce acrylic fibers by melting acrylic polymers in high pressure with water and acetonitrile.

A other U.S. Pat. No. 7,541,400 B2 describes a melt blendable thermoplastic composition that can be obtained using polyacrylonitrile, metals salts and boron compounds with thermal stabilizer, but these formulations can not be used for acrylic fibers and carbon fiber production, mainly due low stretch and high ash content.

Technical State Deficient Points

By economic and environmental issues on the traditional processes, wet spinning and dry spinning, are necessary the recovery and recycling of all used solvents that are highly water and soil polluters and, also, result in a security risk to the employees due to their toxicity.

In the processes based on the utilization of melt processable acrylic polymers, the raw high cost, the high polymerization time, the polymerization difficulties in a continuous process and the polymer flocculation difficulties in emulsion state, can be highlighted as disadvantages. These problems turns melt acrylic polymers economically impracticable to textile applications and others, when compared to the ones obtained by the conventional processes.

In the processes that involve the melting polyacrylonitrile with water under pressure to the fiber production various technical and economic impediments are found that makes them not competitive when comparing to the ones obtained by the actual processes, wet spinning and dry spinning, because of the difficult of being transformed in continuous processes and impossibility of achieving its industrial application with the processes actually available.

### INVENTION SUMMARY

Thinking on these inconvenients and after a lot of studies and researches, the inventor created and developed a newer thermoplastic polyacrylonitrile fiber fabrication process by extrusion, that has advantages over the conventional processes, because it allows a great cost reduction due to the no, or few, solvent utilization, making that the fibers have more than textile applications, as, for example, substitute asbestos, thermic isolations, reinforcements for cement and heat resistant fiber.

As described on the Brazilian patent PI0602706-7 and on the WIPO PCT/BR2007/000162, the polyacrylonitrile can be kept molten by means of high polarity and high melting point, mainly consisting of polyols, such as glycerin, for a reasonable time to allow its thermoplastic conformation.

Through researches and subsequent studies was observed that in those conditions, the nitrogen, responsible for the cross links formation that turns the chain rigid and the material infusible, is protected and the cyclization mechanism, which is accompanied by high energy release, can be controlled, leaving the melting zone in relatively low temperatures and distinct of the degradation zone; the polyols, after the polyacrylonitrile melting and cooling, are incorporated into the polymer, similar to what occurs with PVC, which also turns itself thermoplastic after plasticizers addition such as phthalic acid esters, the whole polyacrylonitrile melting and plasticization process occurs directly on the extruder, allowing that the molten material is formed in molds, this new process produces a material that will be called “thermoplastic polyacrylonitrile”.

Among the thermoplastic polyacrylonitrile main characteristics are its low combustibility, since during its burning it produces a carbon rich residue that extinguishes and prevents the fire spread and, therefore being polar, it has miscibility with polyvinyl chloride (PVC) and with polyvinylidene chloride (PVDC) when melted, allowing polymeric blends production with anti-flame capability, can be recycled like other typical thermoplastic polymers such as polyethylene, polypropylene, polystyrene and PET, various substances can be incorporated to the thermoplastic polyacrylonitrile to improve its stability during melting and conformation processes, it also allows its blending with biodegradable polymers such as polylactic acid (PLA), polyhydroxybutyrate (PHB), polyhydroxyvalerate (PHV) increasing its biodegradation ability and also allows the low toxicity and biodegradable substances incorporation, such as fatty acids esters acids as glycerin and sugar alcohols, ethoxylates polyols, such additives and lubricants in the extrusion processes, improving their processability.

The plasticizers and stabilizers used in the thermoplastic polyacrylonitrile obtaining process have a low environmental and biological toxicity level and all the wasted residues can be easily treated because they are soluble in water and converted into polyols and salts with alkaline pH that is not toxic and has high biodegradability.

The substances added to polyacrylonitrile result in a higher polymer thermal stability, enabling a better processability in terms of permanence within the extruder or injector and also reducing its viscosity, facilitating the flow in molds, dies and spinnerets, preventing the degradation films formation on internal and heated metal surfaces from screws and matrixes. The gain in thermal stability also allows a resistant and transparent film production, filaments obtainment with stretching up to 200 times, pigments incorporation with the purpose of obtaining colored fibers, fibers obtainment from carbon fiber pre-cursors and PANOX, laminates obtainment that can be formed by vacuum forming process, rigid tube obtainment that can be softened and conformed by applying hot air or steam, pellets production that can be used on conventional extruders or injectors, polymer blends production with anti-flame properties such as PVC and PVDC and any configuration used for conventional thermoplastics.

In its fabrication the Thermoplastic

Polyacrylonitrile also permits the use of:

1) Polyols sugars, for example, erythritol, mannitol, maltitol, sorbitol and xylitol can be used as polyacrylonitrile plasticizers with the aim of obtaining materials with lower hygroscopicity than those using glycols With the use as plasticizers of hygroscopic polyols from glycols family and these ones can be highlighted, glycerin, ethylene glycol, diethyleneglycol, triethyleneglycol, polyethylene glycol, propylene glycol, Polypropylene glycol, 1,4-butanediol, 1,5-pentanediol and 1,6-hexanediol, together the alcohols sugar type polyols such as mannitol, sorbitol, erythritol and xylitol that have low water absorption, is possible to adjust the produced thermoplastic polyacrylonitrile hygroscopic rate. Produced samples containing 23% of glycerin as plasticizer are highly hygroscopic and absorb 5.5% of water at 25° C. for 30 days of exposure to an 80% relative humidity, were even possible to see droplets on the surface. Films produced with this same sample showed a 48° contact angle with water, a surface energy of 121 mJ/m² and excellent adhesiveness with epoxy and polyvinyl acetate basis glues. With total replacement of glycerin by mannitol as PAN plasticizer the water absorption was reduced to 1.2% in 30 days under the same environmental conditions.
2) Mono, di and triesters glycols and alcohol sugars with vegetable origin fatty acids can be used as plasticizers and, at the same time, as lubricants in the polyacrylonitrile extrusion processes and among them are the 92% glycerin monostearate (42% of glyceril monostearate with glyceryl di and tristerate mixture), the glyceryl monoleate (55% glyceryl monomiristate with glyceril di and trimiristate mixture), the glyceryl monopalmitate and its mixtures with glyceryl di and tripalmitate, the sorbitan monostearate, the glyceryl monolaurate, the sorbitan monoleate, the sorbitan monolaurate, the glyceril monorricinoleate and ethylene glycol monoricinoleate. Among the various tested substances in this group, those that had better miscibility with PAN were the 42% glyceryl monostearate with di- and triesters mixtures, the 50% of mono- and dipalmitate glyceryl mixture, the 90% glyceryl monoleate, sorbitan and ethylene glycol monostearate. These additives are well incorporated into the PAN when mixed with polyols and act by reducing the molten polymer adhesion in the internal surfaces of the extruder, especially the screw. By being esters with hydrophobic characteristics they also reduce the thermoplastic polyacrylonitrile hygroscopicity. Liquid esters at environmental temperature as oleates are easily mixed with the PAN powder and the solids and pasties such as palmitate and stearates need to be prior melted to better mixing.
3) Vegetable polyols oils such as soybean oil and castor oil, ethoxylated or not, may also be polyacrylonitrile plasticizers and the most satisfactory are the ones with higher hydroxyl rates. From this family were tested the following polyols: soybean oil polyol with 150 mg KOH/g of hydroxyl index, soybean oil polyether polyol with 400 mg KOH/g of hydroxyl index, castor oil polyol with 50 to 400 mg KOH/g of hydroxyl index.
4) Biodegradable polymers such as polylactic acid (PLA), poly hydroxybutyrate (PHB) and polyhydroxyvalerate (PHV) which increase the biodegradation properties of things produced with thermoplastic polyacrylonitrile mainly in soil and water. It is possible to produce PAN blends with 20% of PHB or PHB/PHV and 21% of glycerol concentration, resulting in a product capable of forming films and fibers with approximately 40% of biodegradable substances. The PCL as a biodegradable polymer with melting temperature around 58° C. when added in a 10% proportion in blends with copolymerized PAN with 6% of polyvinyl acetate causes a 15° C. lowering in the softening temperature.
5) Various substances added during the PAN plasticizing stage as carbon nanotubes, colloidal silver, carbon black and diamond powder, including the organometallic compounds, permits the production of acrylic fibers, panox fiber and carbon fibers production with special properties, such as carbon fibers modified with silicon carbide (SIC) can be obtained by adding silicon dioxide or silicone during PAN precursor fiber extrusion and spinning process. The SiC in this fiber is generated by the silicon compounds reduction by carbon when the precursor fiber is carbonized. Carbon fibers with catalytic properties, for example, in hydrogenation, may also be produced by precious metals compounds addition, which decompose themselves thermally in PAN precursor fiber pre-oxidation and carbonization. Among them are the ammonium hexa chloroplatinate (IV) that was added in 0.2% proportion in PAN and produced a carbon fiber with 0.1% of platinum with oxidation property the methyl and ethyl alcohols to the corresponding aldehydes at 180° C. Another carbon fiber type containing 0.1% of palladium was produced by the PAN thermoplastic spinning containing palladium dimethylglyoximate (II).
6) Organic and inorganic pigments in the conformation process to produce pigmented fibers in mass. The PAN mass pigmentation for spinning fiber by wet spinning process is only possible using insoluble pigments in dimethylformamide (DMF), which are few, expensive and in low concentrations to not cause the spinnerets clogging that have holes with typical diameters from 15 to 30 micrometers. For this reason the most used process for coloring acrylic fibers is the dyeing by the use of dyes that are fixed on the PAN copolymer surface with polyvinyl acetate or polymethyl metacrylate. Pigments addition such as titanium dioxide, carbon black, phthalocyanine, barium sulfate or any other can be performed directly in the mixture with PAN powder before its plasticizing. The thermoplastic polyacrylonitrile pigmentation is easily done with the addition of up to 5% of titanium dioxide anatase to produce opaque white tubes very similar to PVC pipe. Colored pigments such as phthalocyanine, widely used in PP, PE and others pigmentations can be added to PAN during its plasticizing in glycerin paste form with 50% of pigment.
7) Vegetal glycerin derived from biodiesel production, containing approximately 85%, is an excellent low cost plasticizer for thermoplastic polyacrylonitrile production and therefore is a potential consumer market for this glycerin, which is considered an industrial waste in many countries such as Brazil. This glycerin that is pasty and in brown color that contains as principal contaminants methanol, water, sodium hydroxide or potassium and free fatty acids, can be incorporated in polyacrylonitrile in the proportion of 40% of the total pure glycerin used. The thermoplastic material produced shows orange color, good rheology for acrylic fibers production for textile use, but is not suitable for carbon fiber production because the sodium and potassium content in the precursor fiber. Moreover, the vegetal glycerin needs its alkalinity neutralization with sulfuric or hydrochloric acid before being used to avoid destabilization of the PAN during the melting.

The characterization of this Invention Privilege patent application now proposed is done by representative figures of the “THERMOPLASTIC POLYACRYLONITRILE PRODUCTION PROCESS”, this way, the process can be fully reproduced by appropriate technique.

From the compiled figures is based the descriptive report part, they are shown with a detailed and consecutive numbering, that explains aspects that may be implied by the representation adopted in order to establish clearly the required protection.

These figures are purely illustrative and may vary.

### INVENTION DRAWINGS BRIEF DESCRIPTION

Then, for better understanding and comprehension of how is the “THERMOPLASTIC POLYACRYLONITRILE PRODUCTION PROCESS” which here is requested, illustrative figures are presented attached:

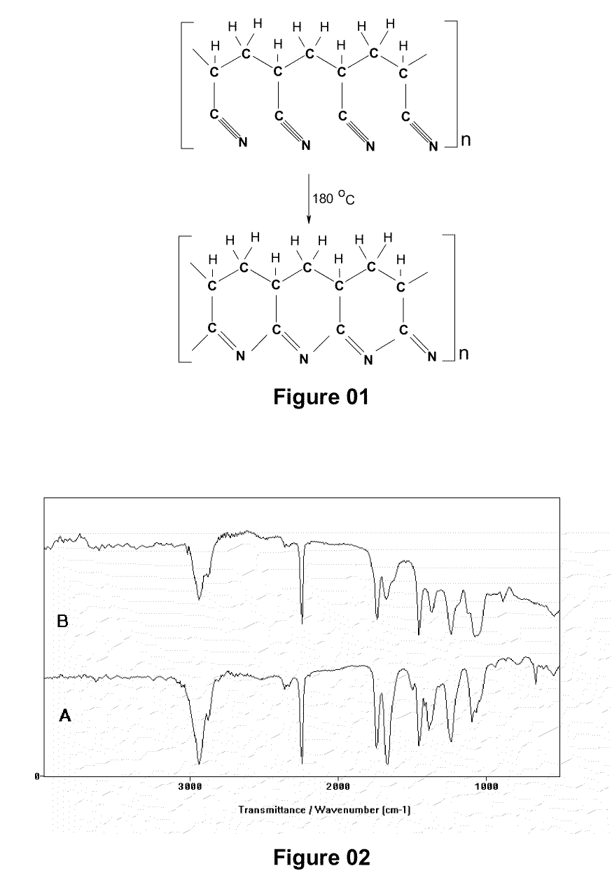

The FIG. 1—Shows the polyacrylonitrile cyclization reaction example.

The FIG. 2—Shows a chart with PAN infrared spectra comparison before and after fusion in terms of light transmission.

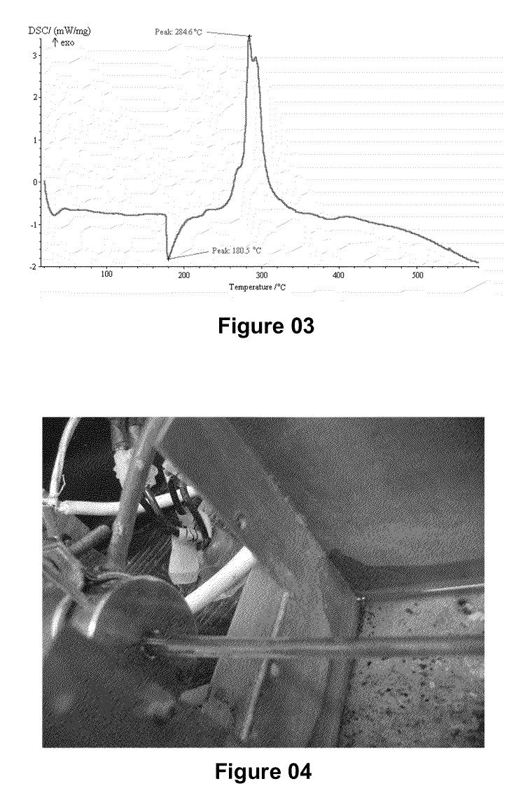

The FIG. 3—Shows a chart with a DSC thermal analysis, where copolymerized polyacrylonitrile with 6% of vinyl acetate, plasticized with diethylene/triethyleneglycol and stabilized with 10% of polyvinyl chloride (PVC), shows melting peak at 180° C. and exothermal cyclization peak at 280° C.

The FIG. 4—Shows a molten polyacrylonitrile flow at 230° C. in a matrix with a 6 mm diameter hole.

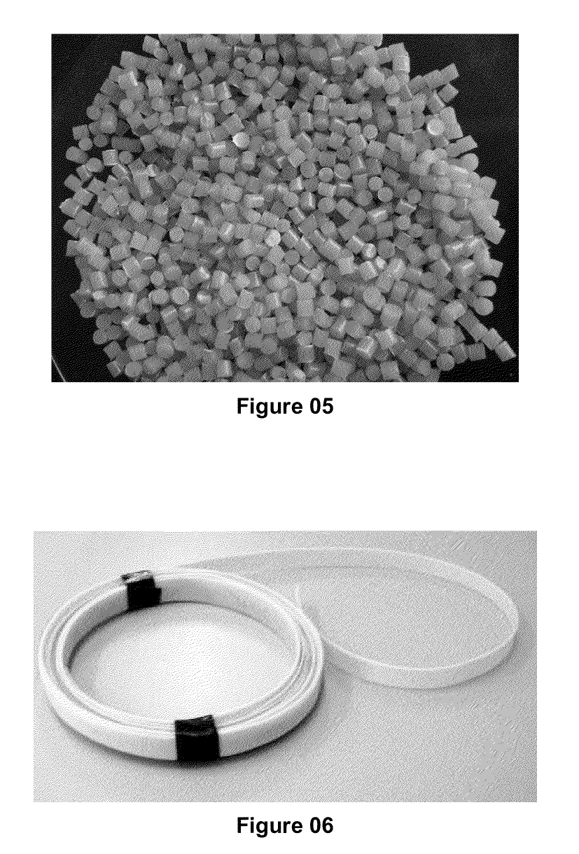

The FIG. 5—Shows a thermoplastic polyacrylonitrile pellets samples obtained in accordance with Example 01 on the invention detailed description.

The FIG. 6—Shows a thermoplastic polyacrylonitrile tape samples obtained in accordance with Example 02 on the invention detailed description.

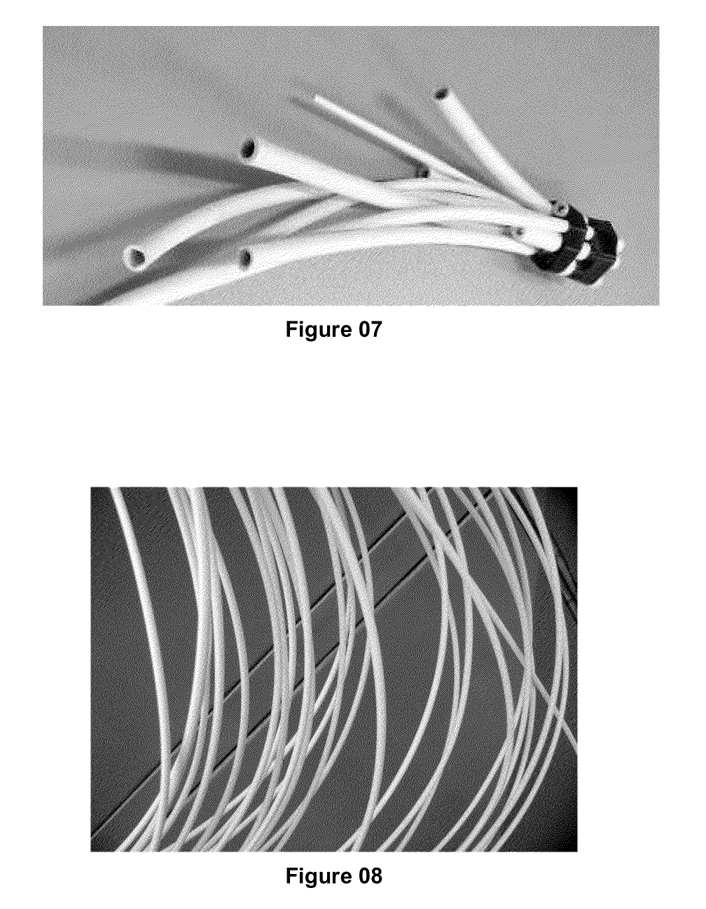

The FIG. 7—Shows a thermoplastic polyacrylonitrile tube samples obtained in accordance with Example 03 on the invention detailed description.

The FIG. 8—Shows a thermoplastic polyacrylonitrile rigid cable samples obtained in accordance with Example 05 on the invention detailed description.

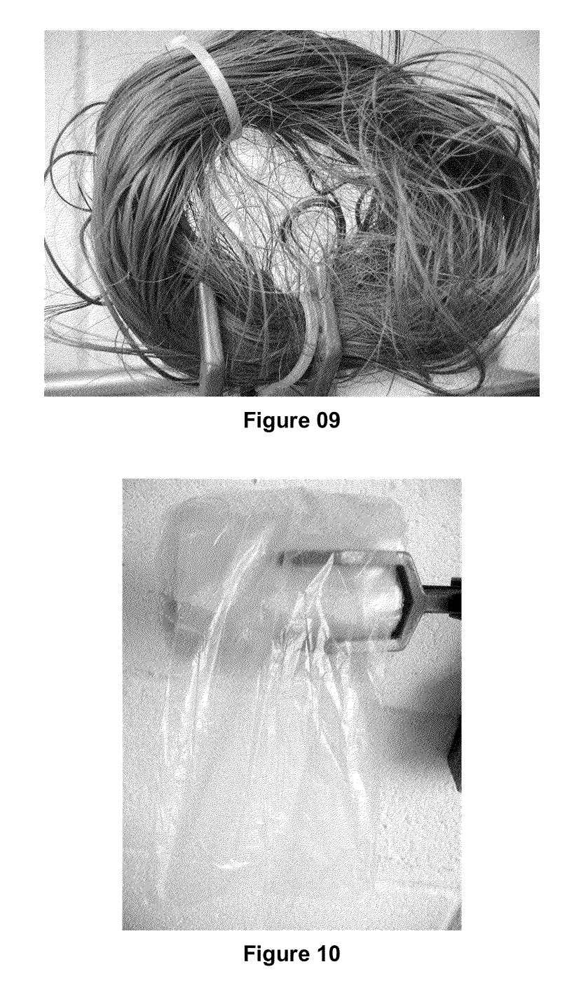

The FIG. 9—Shows a thermoplastic polyacrylonitrile green fiber sample with 142 filaments cable obtained in accordance with Example 06 on the invention detailed description.

The FIG. 10—Shows a thermoplastic polyacrylonitrile transparent film sample obtained in accordance with Example 07 on the invention detailed description.

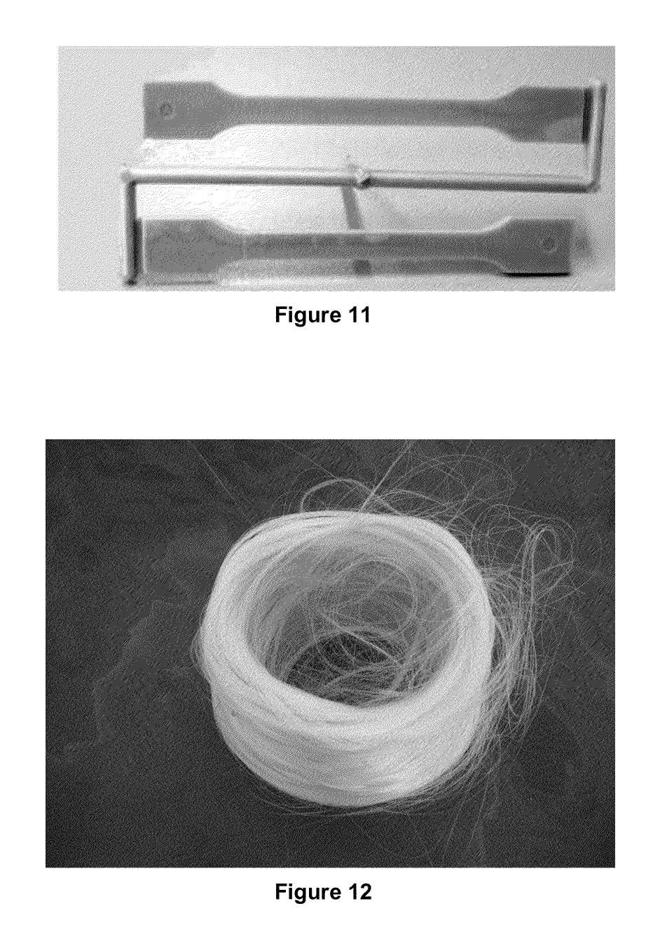

The FIG. 11—Shows a thermoplastic polyacrylonitrile injected piece sample obtained in accordance with Example 08 on the invention detailed description.

The FIG. 12—Shows a thermoplastic polyacrylonitrile fibers sample in a 142 filaments cable form obtained in accordance with Example 09 on the invention detailed description.

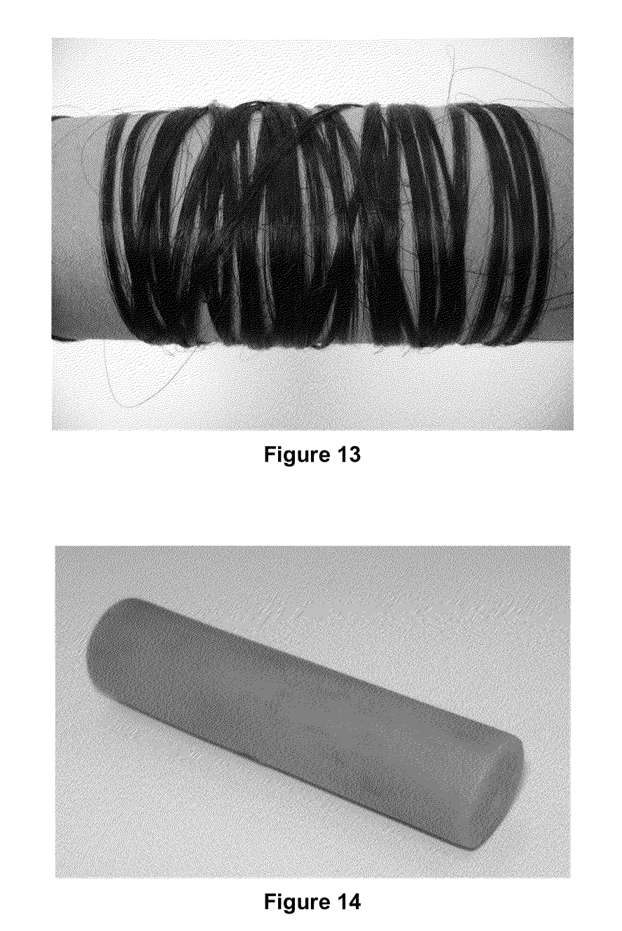

The FIG. 13—Shows a carbon fiber sample obtained in accordance with Example 09 on the invention detailed description.

The FIG. 14—Shows a 16 mm thickness cylinder sample obtained in accordance with Example 11 on the invention detailed description.

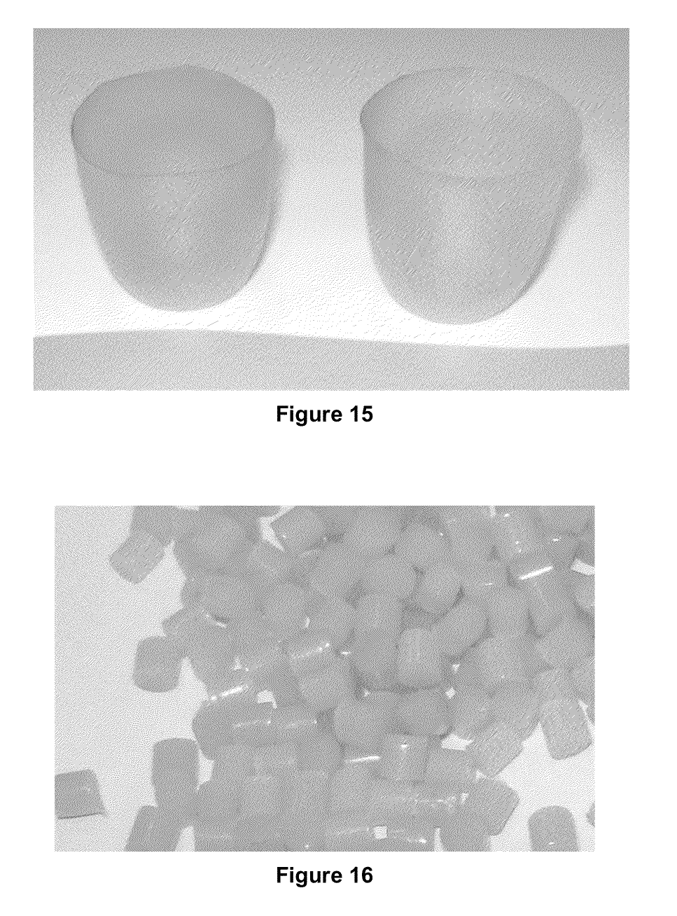

The FIG. 15—Shows a 10 mL containers sample obtained in accordance with Example 13 on the invention detailed description.

The FIG. 16—Shows a PAN/PHB 15% blend pellets sample obtained in accordance with Example 14 on the invention detailed description.

### INVENTION DETAILED DESCRIPTION

This invention describes the process that allows the polyacrylonitrile thermoplastic production, containing the following steps: (I) prepare a acrylic or modacrylic polymer, polyols, and stabilizers mixture, (II) transfer the mixture to an extruder, (III) undergo to an extrusion process step, (IV) obtain the desired polymer shape directly into the extruder or pellets, (V) use the pellets in other equipments such as injection machines, blowers and extruders.

Furthermore, it describes also the use of new substances that when added and incorporated to the polyacrylonitrile result in higher thermal stability of the polymer allowing better processability in terms of increased retention within the extruder or injection, reducing its viscosity and facilitating the flow in molds, dies and spinnerets, thereby avoiding the degradation films formation on the screw and matrixes metal internal and heated surfaces. With this gain in the thermal stability is possible the production of resistant and transparent continuous films, the obtaintion of filaments with stretching up to 200 times, the pigments incorporation, the laminate obtaintion that can be conformed by vacuum forming process, the rigid tubes obtaintion that can be softened and conformed by hot air or steam, the pellets production that can be used in conventional extruders, injectors and blowers; the carbon fiber precursor fiber obtaintion; the oxidized PAN fiber, carbon fiber, the rigid bodies production that can be turned, the blends production with biodegradable polymers such as PHB, PHV, PCL and polylactic acid, the polymer blends production with anti-flame properties with PVC and PVDC, the additives addition and organometallic compounds with the aim of producing acrylic fibers and carbon fiber with special properties, eg catalytic and germicides, the low toxicity substances use such as polyols, mainly glycerin derived from biodiesel production, the PAN production with variable hygroscopic rate through the very hygroscopic glycols use as a glycerin and low hygroscopic polyols as mannitol and erythritol, the low toxicity lubricant additives utilization for the extrusion such as fatty acids esters with glycols and polyols, commonly used in pharmaceutical and food industries, the addition of organohalogen substances use such as halogenated glycols, most commonly derived from glycerin, and high boiling point acids as PAN cyclization retardants, the things and products recycling produced with thermoplastic polyacrylonitrile and any other kind of desired thermoplastic formation.

In the described process, the inventor solved the polyacrylonitrile fusibility problem under normal pressure conditions, making the fusion in an extruder together high polarity plasticizers substances such as polyols and halogenated polyols, which delay or prevent the cyclization, so, in these conditions, the melt polymer can be formed into filaments or otherwise desired. The process also uses plasticizers and additives scientifically known as having low toxicity to humans and to the environment, since all are derived from renewable resources and all waste generated in the thermoplastic PAN production process are easily treated by being soluble in water and converted into polyols, salts and soaps with alkaline pH, thus, are biodegradable.

According to FIG. 01, where can be seem a polyacrylonitrile cyclization reaction example, the invention is based on the discovery that the polymers consisted of copolymerized polyacrylonitrile with different monomers melt in a highly polar environment such as polyols and halogenated polyols, which prevent the nitrile group nitrogen cyclization, so that there is a polymer fusion. Without the nitrogen stabilization, the polyacrylonitrile cyclization begins at approximately 180° C. with great energy release, the cyclization occurs both in atmospheric air presence or in inert gas presence and ionic species present in the polymer can act as initiators, changing the temperature where the cyclization occurs.

This invention is based on the discovery that polymers consisted of copolymerized polyacrylonitrile with different monomers melt in highly polar polyols consisted environment. As it is a high polar environment it prevents the nitrile group nitrogen cyclization so that there is a polymer fusion.

The polyacrylonitrile cyclization reaction is very fast, exothermic and the cyclization may be perceived by the polymer color change, which was originally white becomes yellow, orange and, finally, dark brown, with broken features and infusible, the cyclization also can occur among different polymer chains, resulting in three-dimensional interlacing and this property is used to carbon fibers obtaintion resistant to high temperatures, gases are also released in the cyclization process derived from the chain breaking what makes the polymer expands, loses weight and becomes weak, the products released during the cyclization may be ammonia (NH₃), water (H₂O) and hydrogen cyanide (HCN).

The present invention polymers have more than 35% of units derived from acrylonitrile, copolymerized with one or more comonomers and represented by acrylic units, such as:

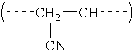

An acrylic polymer is chemically defined as having more than 85% of acrylonitrile units and modacrylic polymers are those that have from 35% to 85% of the weight of acrylonitrile units.

The polyacrylonitrile molecule solvation in highly polar solvents such as water, alcohols and polyols, makes the nitrile nitrogen dipole is preferentially attracted by these hydrogens dipoles substances, preventing the chemical bonds formation with neighboring carbons and the chain cyclization.

The polyols are alcohols that contain two or more hydroxyl per molecule and among them we can highlight the most commons such as the ethylene glycol (MEG), the diethyleneglycol (DEG), the triethylene glycol (TEG), the polyethylene glycol, the propylene glycol and glycerol or glycerin.

Even with the thermoplastic polyacrylonitrile prolonged heating, the cyclization occurs between 5 to 10 minutes after the fusion and this molten form polyacrylonitrile permanence time is too short to its processing in extruders, it was discovered that if some stabilizers are added in small concentrations to polyols, the polyacrylonitrile can remain molten without cyclization for hours, sufficient time to allow its continuous processing, these stabilizers can be: high boiling point inorganic acids such as sulfuric and phosphoric acid, high boiling points halogenated compounds as 1-chloro 2,3-propanediol, 1-fluoro 2,3-propanediol, 1-bromo 2,3-propanediol, 1,3-dichloro 2-propanol, chlorinated polymers such as polyvinyl chloride (PVC) and polyvinylidene chloride (PVDC) and other halogenated polymers such as polyvinyl bromide and polyvinylidene fluoride (PVDF).

According to FIG. 02, where there is a chart with PAN infrared spectra comparison before and after fusion in light transmission terms, was evidenced that the copolymerized polyacrylonitrile with 6% of vinyl acetate has no cyclization, even after being kept molten for 100 minutes in a environment containing 48% of mono ethyleneglycol, 48% of diethylene glycol and 4% of phosphoric acid, the strong band observed at 2240 cm⁻¹ is attributed to the C≡N group stretching vibrations and tends to decrease in intensity during the cyclization, the observed frequencies between 1700 and 1000 cm⁻¹, mainly in 1740 cm⁻¹, correspond to the C═O group stretching mode derived from the comonomer vinyl acetate, during the cyclization occurs the formation of C═O groups which increase the intensity of this band.

The FIG. 02 spectrum A corresponds to the original polyacrylonitrile spectrum copolymerized with 6% of vinyl acetate in film form obtained by the polymer dissolution in DMF and drying at 105° C., the spectrum B corresponds to the same polymer sample that was kept melted to 190° C. for 100 minutes in a ethylene glycol, diethylene glycol and phosphoric acid mixture, it can be noted that in these comparing spectras the cyclization level was small on the melted PAN sample, because the frequency corresponding to the C≡N group remained quite intense and, moreover, the mass viscosity remained satisfactory for extrusion into filaments that are presented in yellow color.

According to FIG. 03, where there is a chart with a DSC thermic analysis where polyacrylonitrile copolymerized with 6% of vinyl acetate, plasticized with diethylene/triethylene glycol and stabilized with 10% of polyvinyl chloride (PVC), has a 180° C. fusion peak, which is relatively distant from the cyclization exothermal peak observed at 280° C., this temperature difference allows a reasonable work area for thermoplastic processing with a low polymer chain cyclization level, the halogen presence in the polymer form or halogenated glycol added to polyacrylonitrile as comonomer decreases the cyclization rate to the point that it becomes possible to show its fusion temperature, the exothermic reaction can reach 8 mW/mg with these chlorine compounds addition to the polymer does not reach more than 4 mW/mg.

According to FIG. 04, there is polyacrylonitrile flow melted at 230° C. coming out the 6 mm diameter hole matrix during extrusion at 60 rpm speed, where can be seem the orange color and transparency of the melted polymer.

To better demonstrate the preferred achievements, which are representative, but non-limiting to the experiments, are presented the following examples of this invention, the acrylic copolymers described in this patent were produced by suspension polymerization using potassium persulphate (initiator, oxidizing agent), sodium bisulfite (activator, reducing agent), ferrous ammonium sulfate (redox catalyst) and tetrasodium EDTA (chelating agent), as described methodology in the bibliography, James C. Mason, “Acrylic Fiber Technology and Applications”, Marcel Dekker Inc, 1995, pp. 37 to 67.

### Example 01

According to FIG. 05, approximately 240.0 g of PAN copolymerized with 6% of vinyl acetate (Mw 130,000) was mixed in a blender under agitation with 100.0 g of glycerin, 50.0 g of triethylene glycol (TEG), 1.5 g of 3-chloro-1,2-propanediol and 2.5 g of sulfuric acid 50%, the mixture was heated under agitation to 150° C. for 20 minutes and cooled for 1 hour, the mass obtained was classified in a passing fraction sieve less than 100 μm, was separated and fed into a 16 mm screw extruder at a 25 rpm speed, extruded at 60 rpm at 230° C. in the matrix with a 6 mm hole, stretched to get a cable with 2.5 mm in diameter and granulated in pellets form of 4 mm in length, thus, the productivity of the extruder was 1.8 kg/h of thermoplastic polyacrylonitrile.

### Example 02

According to FIG. 06, approximately 240.0 g of PAN copolymerized with 6% of vinyl acetate (Mw 130,000) was mixed in a blender under agitation with 120.0 g of glycerin, 40.0 g of monoethyleneglycol (MEG), 0.75 g of 1,3-dichloro-2-propanol and 5.0 g of sulfuric acid 50%, the mixture was heated under agitation to 150° C. for 20 minutes and cooled for 1 hour, the obtained mass was classified in a passing fraction sieve less than 100 μm, was separated and fed a 16 mm screw extruder at a 20 rpm speed, extruded at 50 rpm at 230° C. in a tape matrix of 2 mm thick by 25 mm wide, in these conditions the extruder productivity was 1.5 kg/h of thermoplastic polyacrylonitrile continuous tape with 1.8 mm in thickness by 23 mm wide.

### Example 03

According to FIG. 07, approximately 240.0 g of PAN copolymerized with 6% of vinyl acetate (Mw 130,000) was mixed in a blender under agitation with 100.0 g of glycerin, 30.0 g of monoethyleneglycol (MEG), 20.0 g of diethyleneglycol (DEG), 0.8 g of 3-fluoro-1,2-propanediol, 10.0 g of phosphoric acid 85% and 6.5 g of titanium dioxide, the mixture was heated under agitation to 170° C. for 20 minutes and cooled for 1 hour, the mass obtained was classified in a passing fraction sieve less than 150 μm, was separated and fed a 16 mm screw extruder at a 20 rpm speed, extruded at 60 rpm at 230° C. in a tube matrix, were obtained extruded tubes with 15 mm in diameter with a 1 mm wall thickness with productivity of 1.5 kg of thermoplastic polyacrylonitrile tubes.

### Example 04

Approximately 240 g of PAN copolymerized with 20% of methyl metacrylate (Mw 160,000) was mixed under agitation in a blender with 100.0 g of glycerin, 60.0 g of mono ethylene glycol (MEG), 5.0 g of 2,3-chloro-1.2-propanediol, 2.5 g of sulfuric acid 50% and 48.0 g of PVC-co-vinyl acetate 67 K factor polymerized in emulsion and dissolved in 150 ml of Tetrahydrofuran (THF) cooled to −3° C., after mixing the components for 15 minutes was left in the oven at 105° C. for 6 hours to complete THF evaporation, the mixture was again heated under agitation in the blender to 130° C. for 40 minutes to components plasticizing and cooled for 1 hour, the mass obtained was classified in a passing fraction sieve less than 200 μm, was separated and fed into a 16 mm screw extruder at a 20 rpm speed, extruded at 60 rpm and 215° C. in 6 mm hole matrix, stretched to get a cable with 3 mm diameter and granulated in pellets form with 3 mm by 5 mm, under these conditions, the productivity of the extruder was 1.8 kg/h of thermoplastic polyacrylonitrile/PVC blend pellets.

### Example 05

According to FIG. 08, approximately 240 g of PAN copolymerized with 20% of methyl metacrylate (Mw 160,000) was mixed under agitation in a blender with 150.0 g of glycerin, 50.0 g of monoethyleneglycol (MEG), 5.0 g of 2,3-chloro-1,2-propanediol, 2.5 g sulfuric acid 50% and 30.0 g of polyvinylidene chloride-co-vinyl chloride (PVDC), the mixture was heated under agitation at 140° C. for 20 minutes and cooled by 1 hour, the mass obtained was classified in a passing fraction sieve less than 200 μm, was separated and fed into a 16 mm screw extruder at 15 rpm speed, extruded at 55 rpm and 215° C. in a 6 mm hole matrix, stretched to obtain a rigid cable with 3 mm diameter and granulated in pellets form, thus, the productivity of the extruder was 1.5 kg/h of thermoplastic polyacrylonitrile/PVDC pellets blend.

### Example 06

According to FIG. 09, approximately 240 g of PAN copolymerized with 6% of vinyl acetate (Mw 130,000) was mixed in a blender under agitation with 60.0 g of glycerin, 110.0 g of triethylene glycol (TEG), 2.5 g of 3-bromo-1,2-propanediol, 5.0 g of phosphoric acid 85% and 4.0 g of green pigment, the mixture was heated under agitation to 140° C. for 20 minutes and cooled for 1 hour, the obtained mass was classified passing fraction sieve less than 200 μm, was separated and fed into a 16 mm screw extruder at a 60 rpm speed at 220° C. in a 142 holes spinneret of 0.3 mm in diameter, the stretching was done in heated rolls at 175° C. to obtain 20 μm filaments with 2.5 DTEX and 210 MPa resistance and a elongation of 25%, the productivity of the extruder was 1.6 kg/h of thermoplastic polyacrylonitrile green fiber.

### Example 07

According to FIG. 10, approximately 150 grams of thermoplastic polyacrylonitrile pellets obtained as in example 01 were re-extruded to 215° C. at 50 rpm in the a 20 mm diameter tube matrix tube with 0.5 mm wall (the feeding of the extruder was made by gravity) the tube was inflated and stretched continuously to obtain transparent films of PAN from 0.05 mm thick by 100 mm wide, the productivity of the extruder was 1.5 kg/h of thermoplastic polyacrylonitrile films.

### Example 08

According to FIG. 11, approximately 200 grams of thermoplastic polyacrylonitrile pellets obtained as in example 04 were injected at 210° C. in order to produce tie form bodies with 155 mm in length and 15 g. These thermoplastic polyacrylonitrile bodies were tested and showed a 53 MPa resistance and elasticity modulus of 2.93 GPa.

### Example 09

According to FIGS. 12 and 13, approximately 150 grams of thermoplastic polyacrylonitrile obtained as in example 01 were extruded at 220° C. in a 16 mm screw with 142 holes spinneret of 0.3 mm diameter at 60 rpm and the pellets feeding by gravity, the stretching was done in the hot rolls heated to 175° C. until the obtaintion of 30 μm filaments titled 8.1 DTEX, with a 250 MPa resistance and elongation of 27%, the productivity was 1.5 kg/h of thermoplastic polyacrylonitrile light brilliant yellow fiber. This fiber was converted in carbon fiber by pre-oxidation at 350° C. and carbonization in argon atmosphere at 1500° C.

### Example 10

Approximately 150 g of thermoplastic polyacrylonitrile pellets obtained as in example 04 were extruded at 215° C., with a 16 mm screw at 50 rpm, in a tape matrix of 2 mm×25 mm and stretched up to a 1 mm thickness by 2.1 mm wide, the productivity was 1.6 kg/h of thermoplastic polyacrylonitrile light yellow fiber.

### Example 11

According to FIG. 14, approximately 480.0 grams of PAN copolymerized with 8% of styrene (Mw 110,000) was mixed under agitation in a blender with a melted mixture containing: 10.0 g of triethylene glycol, 35.0 g erythritol 99%, 25.0 g of glyceryl monoesterato 42% and 8.5 g of 3-chloro-1.2-propanediol. After mixing for 20 minutes was classified in a sieve with passing fraction less than 100 μm and separated. This fraction was fed in a 16 mm screw extruder with feeder adjusted to 36 rpm speed and the extruder screw at 10 rpm. All temperature zones were adjusted to 235° C. including the 12 mm diameter matrix. Under these conditions the productivity of the extruder was 1.0 kg/h of continuous thermoplastic polyacrylonitrile cylinder with 12 mm diameter and light yellow color with absorption of 1.5% of humidity at 27° C. and 80% of relative humidity in 30 days.

### Example 12

Approximately 480.0 g of PAN copolymerized with 10% vinylidene chloride (Mw 90,000) was mixed under agitation in a blender with a melted mixture containing: 30.0 g of mannitol, 50.0 g of glyceryl monomiristate 90% and 8.5 g of 3-chloro-1,2-propanediol. After mixing for 20 minutes was classified in a sieve with passing fraction less than 100 μm and separated. This fraction was fed in a 16 mm screw extruder with feeder adjusted to the 36 rpm speed and the extruder screw at 50 rpm. All temperature zones were adjusted to 241° C. including the 6 mm diameter matrix. Under these conditions the extruder productivity was 1.2 kg/h of thermoplastic polyacrylonitrile cable with 4.5 diameter, flexible and orange color

### Example 13

According to FIG. 15, approximately 480.0 grams of PAN copolymerized with 6% vinyl acetate (Mw 130,000) was mixed in a blender under agitation with a mixture containing: 25.0 g of mannitol, 43.0 g of polyol from castor oil with 300 mg of KOH/g hydroxyl index and 4.2 g of phosphoric acid 85%. After mixing for 20 minutes was classified in a sieve with passing fraction less than 100 μm and separated. This fraction was fed in a 16 mm screw extruder, with feeder adjusted to 36 rpm speed and the extruder screw at 50 rpm. All zones were adjusted to 238° C. including the flat die type matrix to continuous sheet production with 1 mm thickness by 150 mm wide. The lamination was done with 3 cylinders at 110° C. and the obtained sheets presented light yellow color with light transmission at 520 nm of about 85%. From this sheet, the vacuum forming equipment produced small containers of 30 mm in diameter height by 30 mm in diameter and the base with 15 mm in diameter with 10 mL capacity.

### Example 14

According to FIG. 16, approximately 408.0 grams of PAN copolymerized with 6% vinyl acetate (Mw 130,000) was mixed under agitation in a blender with 72.0 g of PHB/HV (Mw 294,000 and 99% purity), 47.0 g of glycerin, 22.5 g of triethylene glycol and 4.8 g of phosphoric acid 85%. After mixing for 20 minutes was classified in a sieve with passing fraction less than 100 μm and separated. This fraction was fed in a 16 mm screw extruder, with feeder adjusted to 35 rpm speed and the extruder screw at 60 rpm. All temperature zones were adjusted to 215° C. including the 6 mm diameter matrix. The handle speed was set up to 110 rpm for stretching up to 3 mm in diameter. The obtained cable was granulated and were produced cylindrical pellets with 3 mm in diameter by 3 mm in length with light yellow color. Was observed in this test that the PHB/HV, which has melting temperature of 164° C., has lower extrusion temperature. Under these conditions the extruder productivity was 1.2 kg/h of thermoplastic polyacrylonitrile pellets with 15% of PHB/HV, light yellow color and with absorption of 3.7% of humidity at 25° C. and 80% relative humidity in 30 days.

For the advantages that it offers, and also, by having truly innovative features that meet all the novelty requirements and originality in the genre, the present “THERMOPLASTIC POLYACRYLONITRILE PRODUCTION PROCESS” meet necessary and sufficient conditions to merit an INVENTION PRIVILEGE patent.

1. “THERMOPLASTIC POLYACRYLONITRILE PRODUCTION PROCESS”, characterized by producing thermoplastic polyacrylonitrile from homopolymers and copolymers containing more than 35% of polyacrylonitrile, that has the following fabrication steps: (I) prepare an acrylic or modacrylic polymer, polyols, stabilizers and additives mixture, (II) transfer the mixture to an extruder, (III) undergo to an extrusion process step, (IV) obtain the desired polymer shape directly into the extruder or pellets, (V) use the pellets in other equipments such as injection machines, blowers and extruders.

2. “THERMOPLASTIC POLYACRYLONITRILE PRODUCTION PROCESS”, according to claim 1, characterized by the utilization as polyacrylonitrile plasticizers, high polarity and high boiling point substances such as polyols, that allows the thermoplastic polyacrylonitrile production.

3. “THERMOPLASTIC POLYACRYLONITRILE PRODUCTION PROCESS”, according to claim 1, characterized by the utilization as plasticizers of polyacrylonitrile homopolymerized and copolymerized, high polarity and high boiling point substances and their mixtures, that allows the thermoplastic polyacrylonitrile production.

4. “THERMOPLASTIC POLYACRYLONITRILE PRODUCTION PROCESS”, according to claim 1, characterized by the use of polyols in thermoplastic polyacrylonitrile production process, the polyols have a chain with two or more hydroxyl per molecule and among them, the most common are the ethylene glycol, diethylene glycol, triethylene glycol, propylene glycol, butylene glycol, 1,4-butanediol, 1,5-pentanediol, 1,5-hexanediol, glycerin, the erythritol, the sorbitol, the mannitol and the xylitol.

5. “THERMOPLASTIC POLYACRYLONITRILE PRODUCTION PROCESS”, according to claim 1, characterized by the use of stabilizers in the thermoplastic polyacrylonitrile production process, which prevent or retard the fused polymer cyclization, such as the high boiling point liquid inorganic acids as sulfuric acid and phosphoric acid, halogenated carboxylic acids as chloroacetic acid, the dichloroacetic acid and trichloroacetic acid.

6. “THERMOPLASTIC POLYACRYLONITRILE PRODUCTION PROCESS”, according to claim 1, characterized by the use of stabilizers in the thermoplastic polyacrylonitrile production process, which prevent or retard the fused polymer cyclization, such as high boiling point halogenated compounds as 3-chloro-1,2-propanediol (α-chlorohydrin), 3-fluoro-1,2-propanediol (α-fluorohydrin), 3-bromo-1,2-propanediol (α-bromohydrin), 1,3-dichloro-2-propanol, 1,3-difluoro-2-propanol and 1,3-dibromo-2-propanol.

7. “THERMOPLASTIC POLYACRYLONITRILE PRODUCTION PROCESS”, according to claim 1, characterized by the use of stabilizers in the thermoplastic polyacrylonitrile production process, which prevent or retard the fused polymer cyclization, such as other polymers and halogenated copolymers as the polyvinyl chloride (PVC), the polyvinyl bromide, the polyvinylidene chloride (PVDC) and polyvinylidene fluoride (PVDF).

8. “THERMOPLASTIC POLYACRYLONITRILE PRODUCTION PROCESS”, according to claim 1, characterized by the use of additives in the thermoplastic polyacrylonitrile production process to reduce the fused polymer adherence inside the extruder, acting as a lubricant and facilitating the polymer flow, such as polyols fatty acid esters and its mixtures, polyols and vegetable oils polyethers like the glyceryl mono, di and tristearate, the glyceryl mono, di and tripalmitate, the glyceryl mono, di and trioleate, sorbitan monostearate, ethylene glycol monostearate, polyols and soybean and castor oil polyethers with hydroxyl index of 200 to 450 mg KOH/g.

9. “THERMOPLASTIC POLYACRYLONITRILE PRODUCTION PROCESS”, according to claim 1, characterized by the use of additives in the thermoplastic polyacrylonitrile production process in order to adjust the polymer hygroscopic rate such as alcohols sugar type polyols with hygroscopicity lower than the glycols, among them, the mannitol, sorbitol, maltitol, xylitol and erythritol.

10. “THERMOPLASTIC POLYACRYLONITRILE PRODUCTION PROCESS”, according to claim 1, characterized by the use of additives in the thermoplastic polyacrylonitrile production process in order to increase the polymer biodegradability such as the polymers, polylactic acid (PLA), polyhydroxybutyrate (PHB) and polyhydroxyvalerate (PHV).

11. “THERMOPLASTIC POLYACRYLONITRILE PRODUCTION PROCESS”, according to claim 1, characterized by the use of additives in the thermoplastic polyacrylonitrile production process in order to obtain special properties such as catalytic, germicides, optical, mechanical, thermal and electrical and among them, these ones can be highlighted: the metallic precursors as the oxides which can be the reduced by carbon, like silicon dioxide, silver oxide, copper oxide, indium oxide, lead oxide and tin oxide, the platinum metal halide complexes like ruthenium, rhodium, iridium, osmium and palladium, which are thermally decomposed to metals like ammonium hexachloroplatinate (IV), ammonium hexachloroiridate (IV), ammonium hexachloruthenate (IV), ammonium hexachlororhodate (III), ammonium hexachloropalladate (IV) and ammonium hexachloroosmate (IV), organic metallic compounds like palladium dimethylglyoxime, nickel dimethylglyoxime and ferrocene, colloidal silver, carbonanotubes.

12. “THERMOPLASTIC POLYACRYLONITRILE PRODUCTION PROCESS”, according to claim 1, characterized by the use of additives in the thermoplastic polyacrylonitrile production process in order to mass polymer pigmentation, such as titanium dioxide, carbon black, barium sulfate, iron oxide, copper phthalocyanine and quinacridones.

13. “THERMOPLASTIC POLYACRYLONITRILE PRODUCTION PROCESS”, according to claim 1, characterized by the use as plasticizer in the thermoplastic polyacrylonitrile production process the biodiesel glycerol, which is characterized by having minimum content of 80% and as typical contaminants, the water, the methanol, the ethanol, sodium and potassium salts and free fatty acids.

14. “THERMOPLASTIC POLYACRYLONITRILE PRODUCTION PROCESS”, according to claim 1, characterized by allowing the production of powder, granules and pellets of thermoplastic polyacrylonitrile, which can be used in the production of injected pieces in molds.

15. “THERMOPLASTIC POLYACRYLONITRILE PRODUCTION PROCESS”, according to claim 1, characterized by allowing the production of powder, granules and pellets of thermoplastic polyacrylonitrile, which can be used in the production of modacrylics and acrylic fibers for textile use or not.

16. “THERMOPLASTIC POLYACRYLONITRILE PRODUCTION PROCESS”, according to claim 1, characterized by allowing the production of powder, granules and pellets of thermoplastic polyacrylonitrile, which can be used in the production of precursor fibers from carbon fiber.

17. “THERMOPLASTIC POLYACRYLONITRILE PRODUCTION PROCESS”, according to claim 1, characterized by allowing the production of powder, granules and pellets of thermoplastic polyacrylonitrile, which can be used in the production of parts formed by blowing process like bottles, drums and packing bottle.

18. “THERMOPLASTIC POLYACRYLONITRILE PRODUCTION PROCESS”, according to claim 1, characterized by allowing the production of powder, granules and pellets of thermoplastic polyacrylonitrile, which can be used in the production of transparent films or not, used in the production of packaging and filtering membranes.

19. “THERMOPLASTIC POLYACRYLONITRILE PRODUCTION PROCESS”, according to claim 1, characterized by allowing the production of powder, granules and pellets of thermoplastic polyacrylonitrile, which can be used in the production of tubes, cylinders, tapes, cables and continuous profiles by extrusion.

20. “THERMOPLASTIC POLYACRYLONITRILE PRODUCTION PROCESS”, according to claim 1, characterized by allowing the production of powder, granules and pellets of thermoplastic polyacrylonitrile, which can be used in the production of sheets to be used in packages thermal conformation (vacuum forming)

21. “THERMOPLASTIC POLYACRYLONITRILE PRODUCTION PROCESS”, according to claim 1, characterized by allowing the production of powder, granules and pellets of thermoplastic polyacrylonitrile blended with organic polymers such as PVC, PVDC and PVDF that have anti-flame properties.

22. “THERMOPLASTIC POLYACRYLONITRILE PRODUCTION PROCESS”, according to claim 1, characterized by allowing the production of powder, granules and pellets of thermoplastic polyacrylonitrile blended with polymers such as polylactic acid, PHB and PHV that have biodegradable properties and might be used in the packaging production.

23. “THERMOPLASTIC POLYACRYLONITRILE PRODUCTION PROCESS”, according to claim 1, characterized by allowing the production of powder, granules and pellets of thermoplastic polyacrylonitrile having glycerol derived from biodiesel production as plasticizer.

24. “THERMOPLASTIC POLYACRYLONITRILE PRODUCTION PROCESS”, according to claim 1, characterized by allowing the production of powder, granules and pellets of thermoplastic polyacrylonitrile that can be used on the production of cylinders and blocks that might be turned.
